(19) United States
(12) Patent Application Publication
(10) Pub. No.: US 2007/0208584 A1
(43) Pub. Date: Sep. 6, 2007

(54) Method and system for managing fundraising campaigns

(75) Inventors: Jeffrey David Kern, New Haven, CT (US); Aviv Aviad, Woodbridge, CT (US)

Correspondence Address: Cornus Consulting, LLC, 121 Judwin Avenue, New Haven, CT, 06515, US

(73) Assignee: Cornus Consulting, LLC

(21) Appl. No.: 11/368,111

(22) Filed: Mar. 6, 2006

(51) Int. Cl. G06Q 10/00; G06Q 30/00

(52) U.S. Cl. 705/1

(57) ABSTRACT

A method of providing greeting cards, the method comprises: providing, over a communication network, a list of potential recipients of a greeting card to multiple potential senders; receiving, from multiple potential senders, selection indication representative of one or more selected recipients and greeting information associated with the selection; generating, for each selected recipient, a greeting card that comprises the greeting information associated with the selected recipient. A system, comprising: an interface, adapted to: (i) provide to a communication network, a list of potential recipients of a greeting card to be sent over the communication network to multiple potential senders; (ii) receive, from multiple potential senders, selection indication representative of one or more selected recipients and greeting information associated with the selection; and a processor, coupled to the interface, adapted to generate, for each selected recipient, a greeting card that comprises the greeting information associated with the selected recipient.

### FIELD OF THE INVENTION

The invention relates to methods, systems and computer readable mediums for generating greeting cards and for managing fundraising campaigns.

### BACKGROUND OF THE INVENTION

Greeting Cards

On various occasions, such as holidays, birthdays anniversaries and the like many people greet other people, send them a greeting card, audio-visual message and even a gift.

One prior art method for sending a greeting includes purchasing a greeting card and sending it to a recipient. Usually a limited number of people share a single greeting card.

U.S. Pat. No. 6,804,806 of Bansal et el. titled “Method of delivering an audio or multimedia greeting containing messages from a group of contributing users” describes a method for delivering a greeting from a group of individuals. Multiple individuals can contribute to the audio or multimedia greeting. A user starts the multimedia greeting generating process by inputting the names and phone numbers (and optionally the internet address) of the recipient and of other people that can contribute to the greeting.

U.S. patent application publication serial number 2002/0138573 of Saguy titled “System for multiple signers on an electronic card and gift”, describes a method and system for collecting greetings from multiple users on a single greeting card and delivering it to a user. The greeting card is sent by a sender that can invite an unlimited amount of invitees to add their greetings. Each invitee is also encouraged to add as many invitees he wants. The greeting process starts by asking the sender to enter the first name, email address and an optional invitee-specific note to each invitee.

Fundraising Campaigns

Various prior art methods for fundraising exist. Some fundraising methods are based upon old religious traditions. For example, many synagogues or Jewish schools use an old Jewish custom of sending baskets of goods to people on the Purim holiday. The fundraising process includes the following stages: (i) Each family member of the synagogue (or Jewish school) receives, prior to the holiday, a list of all the members of that synagogue (or Jewish school), (ii) each family member can select the recipients of holiday baskets, (iii) the selection is sent to the synagogue (or Jewish school) as well as a donation, (iv) an administrator receives all selections and rearranges the sender-recipient information to a recipient-sender format, either manually or with the aid of a database program(v) sends to each recipient a holiday basket and a standard greeting card that includes the names of all the donating members that requested to send the holiday basket to that recipient.

This fundraising method was relatively limited to certain holiday baskets, to predefined greeting cards and was time consuming. In addition, only the administrator was able to evaluate the fundraising status as well as the amount of greetings per family member.

Additional prior art for fundraising, some using Wide Area Networks such as the Internet, also evolved. U.S. patent application publication serial number 2005/0261931 of O'hara, titled “System and method of fund raising utilizing prepaid gift certificates/gift cards” describes a system and method of fundraising utilizing prepaid gift certificates or gift cards. The system includes a program coordinator, a distributor, a fundraiser, and at least one vendor that generates prepaid certificates or cards. The program coordinator prepares a marketing program including brochure and order form. The program coordinator, or a distributor of the coordinator, places the program with fundraisers. The fundraiser sells vendors' gift certificates or cards, and collects monies and consumer information. The fundraiser keeps their portion of the proceeds and returns the remaining proceeds and consumer information to the program coordinator, or the distributor for forwarding to the coordinator. The program coordinator enters all orders and consumer information. The program coordinator keeps their portion of the money and returns the remaining money and customer information to the vendor. The vendor sends a catalog, a gift certificate or card to the consumer.

U.S. patent application publication serial number 2005/0240433 of Schwartz et al. titled “Method and system for an efficient fundraising campaign over a wide area network” describes a system and method for conducting a fundraising campaign over a wide-area network is provided. The method includes hosting a website, registering on the website, making a charitable donation on the website, contacting third parties via email messages soliciting charitable donations, and providing one or more reports, on the website, including information on the status of the fundraising campaign.

U.S. patent application publication serial number 2005/0228742 of McHale et al., titled “Method and apparatus for creating and conducting on-line charitable fund raising activities with competitive events” describes methods, systems, and program code that enable a nonprofit organization to manage its fundraising activities online. The methods and apparatuses facilitate online hosting of fundraising auctions, and auction services such as maintaining donor/bidder registries, bid tracking, processing credit cards, and auction closeout activities. Participants of a competitive fund raising event can donate items for a charitable auction during the catalog building process and assign either the item value or the eventual sales price of the item to one or more participants.

U.S. patent application publication serial number 2005/0251485 of Quigley titled “Systems for soliciting donations” describes systems for managing and soliciting donations made during checkout of a plurality of online purchases at a plurality of online retailers by a plurality of online shoppers. The system can include a processor for receiving, over a communications network, data regarding a plurality of amounts for donation and a plurality of selected organizations made during checkout of the plurality of online purchases at the plurality of online retailers by the plurality of online shoppers, and collecting a plurality of payments for the plurality of amounts for donation and distributing the plurality of payments among the plurality of organizations based on the data. The system may include the online shoppers being asked at the time of checkout if they would like to round-up their total purchase price to the nearest dollar and select a charity/nonprofit organization to donate the spare change.

There is a need to provide efficient fundraising systems, methods and computer readable mediums and there is a need for providing greeting cards in an efficient manner.

### SUMMARY OF THE INVENTION

A method of providing greeting cards, the method includes: providing, over a communication network, a list of potential recipients of a greeting card to multiple potential senders; receiving, from multiple potential senders, selection indication representative of one or more selected recipients and greeting information associated with the selection; generating, for each selected recipient, a greeting card that comprises the greeting information associated with the selected recipient. Conveniently, the method further includes sending a request to donate money.

A computer program product is provided. The computer useable medium includes a computer readable program, wherein the computer readable program when executed on a computer causes the computer to: provide, via an interface and over a communication network, a list of potential recipients of a greeting card to multiple potential senders; to receive, from multiple potential senders, selection indication representative of one or more selected recipients and greeting information associated with the selection; and to generate, for each selected recipient, a greeting card that comprises the greeting information associated with the selected recipient. Conveniently, the computer program further causes the computer to request to donate money.

A system that includes: an interface, adapted to: (i) provide to a communication network, a list of potential recipients of a greeting card to be sent over the communication network to multiple potential senders; (ii) receive, from multiple potential senders, selection indication representative of one or more selected recipients and greeting information associated with the selection; and a processor, connected to the interface, adapted to generate, for each selected recipient, a greeting card that comprises the greeting information associated with the selected recipient. Conveniently, the system is further adapted to request to donate money

A method for sending greeting cards, the method includes: receiving, over a communication network, a list of potential recipients of a greeting card; sending selection indication representative of one or more selected recipients and greeting information associated with the selection; receiving an indication that a greeting card that comprises greeting information associated with a certain recipient was sent or will be sent to a selected recipient;.wherein the greeting information is provided from multiple senders. Conveniently, the method further includes donating money.

A computer program product is provided. The computer useable medium includes a computer readable program, wherein the computer readable program when executed on a computer causes the computer to: receive, over a communication network, a list of potential recipients of a greeting card; send selection indication representative of one or more selected recipients and greeting information associated with the selection; and receive an indication that a greeting card that includes greeting information associated with a certain recipient was sent or will be sent to a selected recipient; wherein the greeting information is provided from multiple senders. Conveniently, the computer program further causes the computer to process a money donation.

A system that includes: an interface, adapted to receive, over a communication network, a list of potential recipients of a greeting card; a processor adapted to send, via the interface, selection indication representative of one or more selected recipients and greeting information associated with the selection; wherein the interface is further adapted to receive an indication that a greeting card that comprises greeting information associated with a certain recipient was sent or will be sent to a selected recipient; wherein the greeting information is provided from multiple senders. Conveniently, the system is further adapted to donate money.

### BRIEF DESCRIPTION OF THE DRAWINGS

The present invention will be understood and appreciated more fully from the following detailed description taken in conjunction with the drawings in which:

FIG. 1 illustrates a system for providing a greeting card, according to an embodiment of the invention;

FIG. 2 illustrates a method for providing a greeting card, according to an embodiment of the invention;

FIG. 3 illustrates a fundraising method, according to an embodiment of the invention;

FIG. 4 illustrates a method for sending a greeting card, according to an embodiment of the invention;

FIG. 5 illustrates a method for participating in a fundraising campaign, according to an embodiment of the invention; and

FIG. 6 illustrates an exemplary display, according to an embodiment of the invention.

### DETAILED DESCRIPTION OF THE DRAWINGS

The invention provides a system, method and computer readable medium that enable multiple potential senders to generate a greeting card that include greeting information from each sender, thus providing a personalized greeting card. The greeting information can be selected from a group of predefined greeting information but can also generated by the senders.

The system, method and computer readable medium simplify the greeting card provision process by sending potential senders a predefined list of potential recipients, thus a sender can elect to send multiple greeting cards to a large number of recipients without undergoing the time consuming stage of providing recipient information, including the recipient email address, phone number, checking that the recipient information is correct and the like.

Conveniently, the potential recipients are arranged in groups and the sender can select one or more group, thus further simplifying the provision of greeting cards to large numbers of recipients.

Conveniently, the senders use a computer that is connected over a communication network to a central entity such as a server. The senders can receive requests to participate in the generation of a greeting card, as well as select recipients and provide greeting information by using the computer.

Conveniently, lists of senders that requested to send a greeting card to a certain recipient can be generated and also distributed to various senders as well as to potential senders. The lists can also represent the greeting information provided by the various senders.

According to an embodiment of the invention the system enables multiple persons to act as administrators, and also enable potential and actual senders to receive feedbacks relating to the generation of the greeting cards, to the progress of a fundraising process and the like.

The invented system is placed over the network and enables each participant member with an access to the network to make its selection directly to the system rather than using a paper form.

The system on the network enables multiple administrators to use the system at the same time.

The system, method and computer readable medium can be used in various occasions, and the list of potential recipients can include employees of one or more companies, member of certain clubs, members of a certain community, members of a school or other educational organization and the like.

According to an embodiment of the invention default greeting information can be defined to be sent when senders do not provide their own greeting information. Thus, standard greeting can be sent in behalf of senders that did not add a unique greeting.

It is noted that greeting information can include a greeting, text, audio message, visual message, as well as information that describes such information. For example if a sender can select one out of multiple predefined greetings that the information that selects the greeting can be referred to as greeting information.

According to yet further embodiments of the invention the provision of greeting cards is accompanies by fundraising. The recipients can be requested to donate money to a certain cause. Some of the donated money can be utilized for managing the fundraising campaign, purchasing presents to the recipients and the like.

Conveniently, the amount of donated money can be set in advance and a sender can be requested to select between some predefined fixed amounts of money. These amounts can be associated to the number of people that the recipient wishes to send the greeting card (and/or gift).

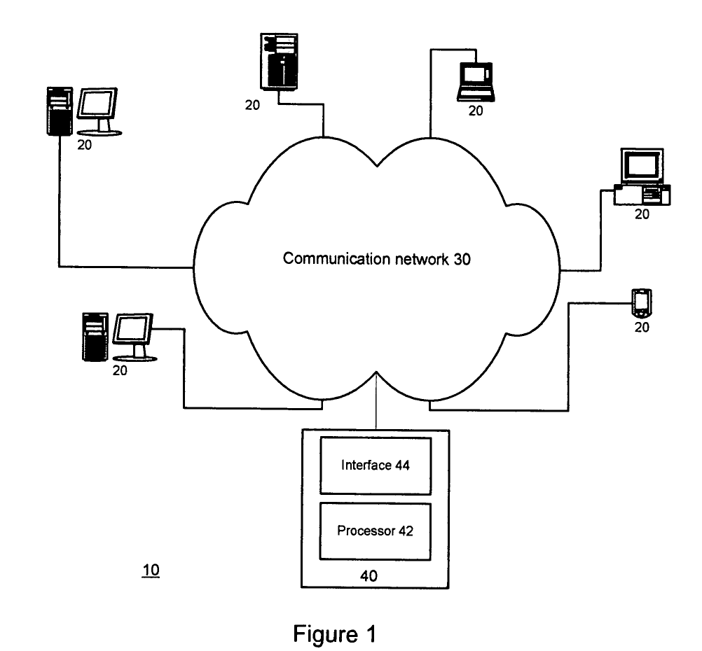

FIG. 1 illustrates system 10 for providing a greeting card, according to an embodiment of the invention.

System 10 includes multiple computers (collectively denoted 20) that are connected, over communication network 30, to a device 40 that include processor 42 and an interface 44. The device 40 can be a computer, a server, multiple computers, multiple servers, can include integrated components as well as distributed components and the like. The communication network can include local area networks, wide area networks, the Internet, wireless networks, wired networks and a combination thereof. The processor can include one or more microprocessors, memory units, DMA controllers and the like, The interface can include memory units, I/O ports, network adaptors, bridges and the like.

Conveniently, the device 40 hosts a web site that can be accessed by multiple senders that use their computers 20.

At least one of computers 20 and even device 40 can be used by one or more administrator that can manage the process of generating a greeting card or manage a fundraising campaign. The administrator conveniently prepares the list of potential recipients. There can be many lists and the administrator can select a list per fundraising campaign.

Conveniently, the system can receive manual input (that can be inputted by the administrator) representative of other selection indication and to provide a discount to potential senders that send selection indication over the communication network.

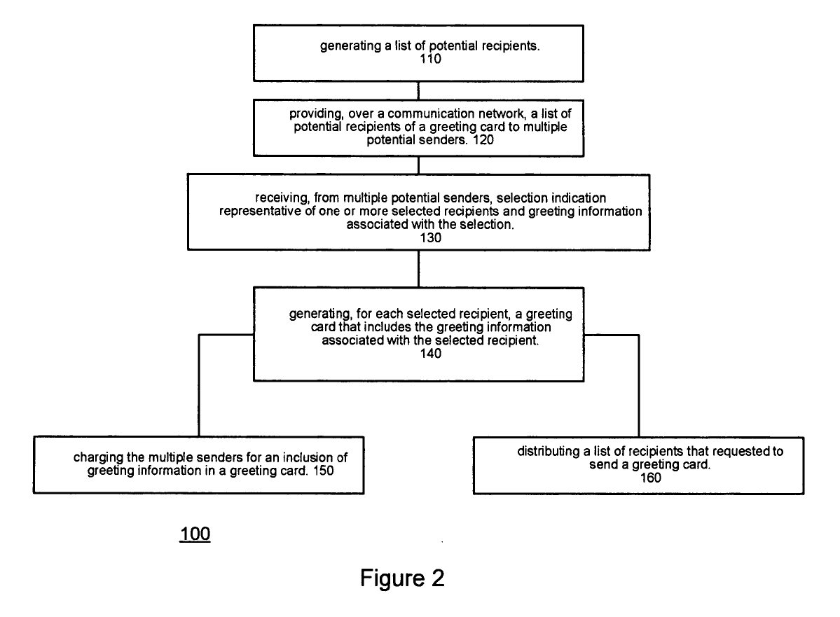

FIG. 2 illustrates a method 100 for providing a greeting card, according to an embodiment of the invention.

Method 100 starts by stage 110 of generating a list of potential recipients. The list can be generated by one or more administrators, can be updated over time, potential recipients can be added or removed, conveniently before a certain greeting card generation process starts. It is noted that an administrator can generate the list of potential recipients by selecting them out of a larger list of potential recipients.

Stage 110 is followed by stage 120 of providing, over a communication network, a list of potential recipients of a greeting card to multiple potential senders. The potential senders can be selected in response to some link or association with the potential recipients. For example, the potential senders as well as the potential recipients can belong to the same community, to the same company and the like.

According to an embodiment of the invention the potential recipients can be grouped in multiple groups. In such a case the list of potential recipients can include multiple groups of potential recipients. The senders can select between one or more groups, thus simplifying the selection process.

The grouping can be based upon social or other links between the group members. For example, if the potential recipients are family members of students of a certain school the groups can include their teachers, family members of the students of certain classes, and the like.

Stage 120 is followed by stage 130 of receiving, from multiple potential senders, selection indication representative of one or more selected recipients and greeting information associated with the selection.

Stage 130 is followed by stage 140 of generating, for each selected recipient, a greeting card that includes the greeting information associated with the selected recipient. Thus a personalized greeting card can be provided.

Conveniently, stage 140 includes generating multiple greeting cards to multiple recipients. Thus, not just one greeting card can be sent to one recipient but the method can enable to concurrently send multiple greeting cards to multiple recipients, wherein each card is tailored to the recipient. A greeting card that is aimed to a certain recipient can include the names of each sender that requested to send a greeting card to that certain recipient as well as greeting information provided by each sender.

Stage 140 can include generating a greeting card that is sent to the computer of the recipients, or can even include printing the greeting card or otherwise imprinting a media that can convey a visual or audio-visual message.

Stage 140 can be followed by stage 150 of charging the multiple senders for an inclusion of greeting information in a greeting card. It is noted that stage 150 can precede stage 140 or can be executed in parallel to stage 140.

Stage 110 can also include defining a time window for receiving requests from the potential senders. Stage 120 can include providing the potential senders time window information representative of the defined time window.

Stage 140 can also be followed by stage 160 of distributing a list of recipients that requested to send a greeting card.

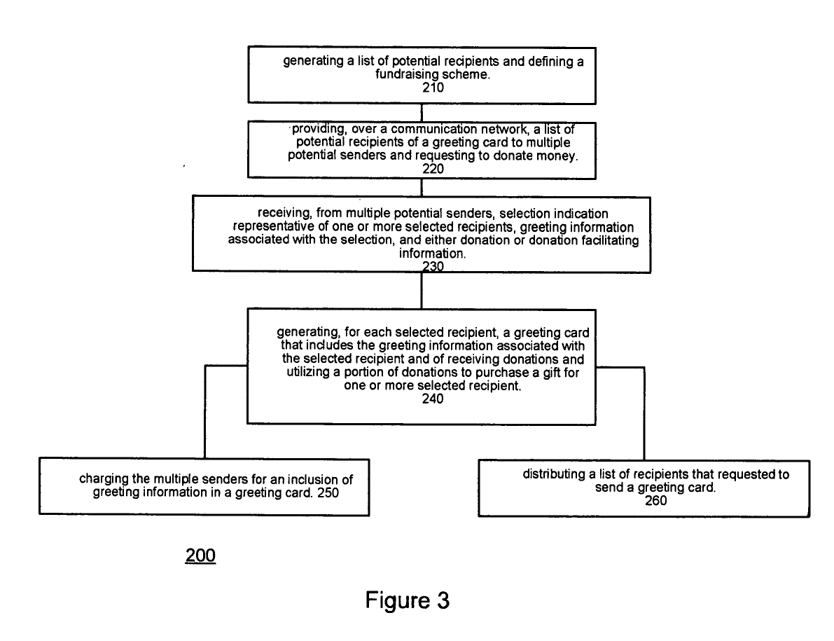

FIG. 3 illustrates a fundraising method 200, according to an embodiment of the invention.

Method 200 starts by stage 210 of generating a list of potential recipients and defining a fundraising scheme. The fundraising scheme can include the amounts of money to be requested from the senders, a target aggregate sum of donated money, the usage of the donated money and the like. Stage 210 can include defining multiple amounts of requested donated money in response to an amount of selected recipients.

Stage 210 is followed by stage 220 of providing, over a communication network, a list of potential recipients of a greeting card to multiple potential senders and requests to receive money.

Stage 220 is followed by stage 230 of receiving, from multiple potential senders, selection indication representative of one or more selected recipients, greeting information associated with the selection and either donation or donation facilitating information.

It is noted that the selection can be done over the communication network or another automated manner but can also dome manually, by using the mail or other paper formats. Potential senders that user the automatic manner can receive a discount.

Stage 230 is followed by stage 240 of generating, for each selected recipient, a greeting card that includes the greeting information associated with the selected recipient and utilizing a portion of donations to purchase a gift for one or more selected recipient.

Stage 240 can be followed by stage 250 of charging the multiple senders for an inclusion of greeting information in a greeting card.

Stage 240 can also be followed by stage 260 of distributing a list of recipients that requested to send a greeting card.

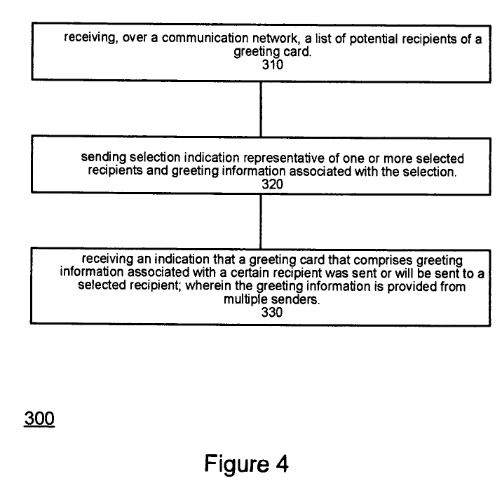

FIG. 4 illustrates a method 300 for sending a greeting card, according to an embodiment of the invention.

Method 300 starts by stage 310 of receiving, over a communication network, a list of potential recipients of a greeting card. Stage 310 can include receiving a list that is partitioned to multiple groups of potential recipients.

Stage 310 is followed by stage 320 of sending selection indication representative of one or more selected recipients and greeting information associated with the selection. Stage 320 can include selecting one or more group of potential recipients out of the list of potential recipients

Stage 320 is followed by stage 330 of receiving an indication that a greeting card that comprises greeting information associated with a certain recipient was sent or will be sent to a selected recipient; wherein the greeting information is provided from multiple senders.

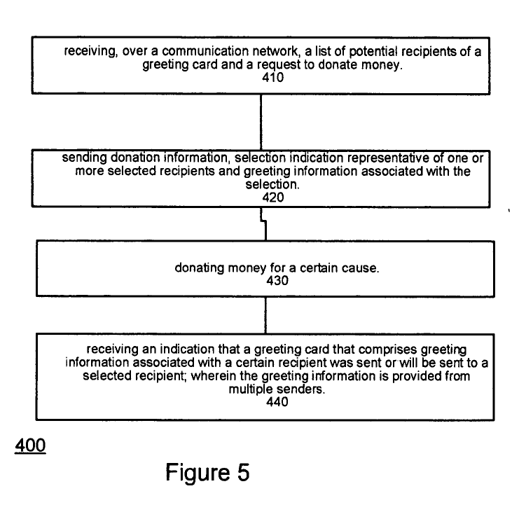

FIG. 5 illustrates a method 400 for participating in a fundraising campaign, according to an embodiment of the invention.

Method 400 starts by stage 410 of receiving, over a communication network, a list of potential recipients of a greeting card and a request to donate money. Stage 410 can include receiving various sums of money from which the sender can select. The various amount of money can be associated with the amount of recipients to which the sender wants to send greeting cards. Stage 410 can include receiving a list that is partitioned to multiple groups of potential recipients.

Stage 410 is followed by stage 420 of sending donation information, selection indication representative of one or more selected recipients and greeting information associated with the selection. The donation information can indicate the amount of money the sender wishes to donate, for what purpose is the money donated and can also facilitate the donation. Such information can include a credit card number and the like. Stage 420 can include selecting one or more group of potential recipients out of the list of potential recipients.

Stage 420 is followed by stage 430 of donating money for a certain cause.

Stage 430 is followed by stage 440 of receiving an indication that a greeting card that comprises greeting information associated with a certain recipient was sent or will be sent to a selected recipient; wherein the greeting information is provided from multiple senders.

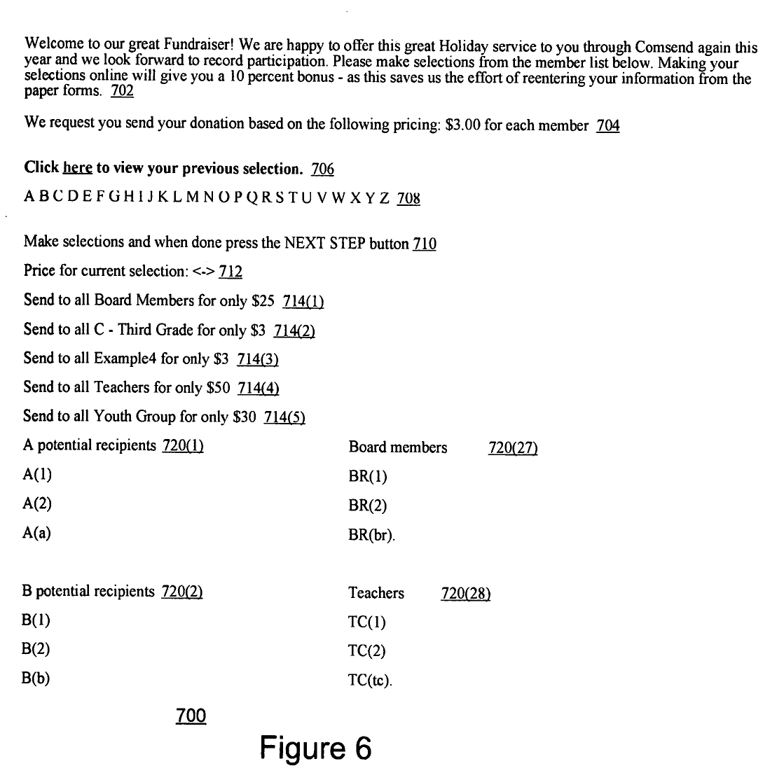

FIG. 6 illustrates an exemplary display 700, according to an embodiment of the invention.

This display 700 is displayed to a potential sender in order to initiate the fundraising process.

The displayed text includes a preamble 720 “Welcome to our great Fundraiser! We are happy to offer this great Holiday service to you through Comsend again this year and we look forward to record participation. Please make selections from the member list below. Making your selections online will give you a 10 percent bonus—as this saves us the effort of reentering your information from the paper forms”

The preamble is followed by various requests (704, 714(1)-714(5) to donate predefined amount of money as well as an explanation about the relation between the amount of donated money and the number/group of reciptments. Request 704 includes “We request you send your donation based on the following pricing: $3.00 for each member”. Request 714(1) includes: “Send to all Board Members for only $25”. Request 714(2) includes: “Send to all C—Third Grade for only $3”. Request 714(3) includes: “Send to all Example4 for only $3”. Request 714(4) includes: “Send to all Teachers for only $50”. Request 714(5) includes: “Send to all Youth Group for only $30”.

The potential sender can view previous selections he made (see: text 706: “Click here to view your previous selection”.

The potential sender can elect a group of of multiple groups (grouped by letters A-Z), as illustrated by text 708: “A B C D E F G H I J K L M N 0 P Q R S T U V W X Y Z”.

The display also displays various instructions, as illustrated by text 710 :“Make selections and when done press the NEXT STEP button”. Once the next button is pressed the potential sender can add greeting information.

The total amount of donated is also provided, as indicated by text 712: “Price for current selection: <->”.

In addition the various members of each group, as well as the group titles are illustrated. Near each potential recipient name as near each group a window appears. By marking the window the sender selects the recepients of his greeting card. The display illustrated various groups such as group A of potential recepients 720(1), group B of potential recipients 720(2), borad members 720(27), and teachers 720(28). Group A of potential recepients 720(1) includes potential recepients A(1)-A(a), group B of potential recipients 720(2) includes potential recepients B(1)-B(b), borad members 720(27) includes potential recepients BR(1)-BR(br) and teachers 720(28) includes potential recepients TC(1)-TC(tc). It is noted that indexes a,b,tc and br are positive integers.

It is noted that the groups can partially overlap but this is not necessarily so.

Those of skill in the art will appreciate that the greeting card as well as the fundraising management process can be executed by a computer that reads a computer readable medium that includes program code that when executed by the computer causes the computer to provide a greeting card or perform fundraisings.

Conveniently, the computer readable medium can include instructions that cause a computer to execute method 100. Conveniently, the computer readable medium can include instructions that cause a computer to execute method 200. Conveniently, the computer readable medium can include instructions that cause a computer to execute method 300. Conveniently, the computer readable medium can include instructions that cause a computer to execute method 400.

The medium can be a disk, a diskette, a type, a CD, a DVD, a memory chip, a component within a memory chip and the like. The medium can be read by applying magnetic, electromagnetic, electric or optical means or any other form of radiation.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

We claim:

1. A method of providing greeting cards, the method comprises: providing, over a communication network, a list of potential recipients of a greeting card to multiple potential senders; receiving, from multiple potential senders, selection indication representative of one or more selected recipients and greeting information associated with the selection; generating, for each selected recipient, a greeting card that comprises the greeting information associated with the selected recipient.

2. The method according to claim 1 further comprising requesting the multiple potential senders to donate money for a certain cause.

3. The method according to claim 1 further comprising defining multiple amounts of requested donated money in response to an amount of selected recipients.

4. The method according to claim 1 further comprising receiving donations and utilizing a portion of donations to purchase a gift for one or more selected recipients.

5. The method according to claim 1 wherein the providing comprises providing a list of potential recipients that comprises multiple groups of potential recipients and allowing the multiple potential senders to select one or more groups of potential recipients.

6. The method according to claim 1 wherein the generating comprises generating multiple greeting cards to multiple recipients; wherein a greeting card that is aimed to a certain recipient comprises the names of each sender that requested to send a greeting card to that certain recipient as well as greeting information provided by each sender.

7. The method according to claim 1 further comprising generating a list of potential recipients.

8. The method according to claim 1 further comprising charging the multiple senders for an inclusion of greeting information in a greeting card.

9. The method according to claim 1 further comprising defining a time window for receiving requests from the potential senders and providing the potential senders time window information representative of the defined time window.

10. The method according to claim 1 further comprising distributing a list of recipients that requested to send a greeting card.

11. A method for sending greeting cards, the method includes: receiving, over a communication network, a list of potential recipients of a greeting card; sending selection indication representative of one or more selected recipients and greeting information associated with the selection; receiving an indication that a greeting card that comprises greeting information associated with a certain recipient was sent or will be sent to a selected recipient; wherein the greeting information is provided from multiple senders.

12. The method according to claim 11 further comprising donating money for a certain cause.

13. The method according to claim 11 further comprising selecting one or more group of potential recipients out of the list of potential recipients.

14. A system, comprising: an interface, adapted to: (i) provide to a communication network, a list of potential recipients of a greeting card to be sent over the communication network to multiple potential senders; (ii) receive, from multiple potential senders, selection indication representative of one or more selected recipients and greeting information associated with the selection; and a processor, coupled to the interface, adapted to generate, for each selected recipient, a greeting card that comprises the greeting information associated with the selected recipient.

15. The system according to claim 14 wherein the processor is adapted to generate requests to the multiple potential senders to donate money for a certain cause.

16. The system according to claim 15 wherein the processor is adapted to define multiple amounts of requested donated money in response to an amount of selected recipients.

17. The system according to claim 14 wherein the processor is adapted to generate a list of potential recipients that comprises multiple groups of potential recipients and to generate a request to select one or more groups of potential recipients.

18. The system according to claim 14 wherein the processor is adapted to generate multiple greeting cards to multiple recipients; wherein a greeting card that is aimed to a certain recipient comprises the names of each sender that requested to send a greeting card to that certain recipient as well as greeting information provided by each sender.

19. The system according to claim 1 wherein the processor is adapted to define a time window for receiving requests from the potential senders and to send, via the interface, to the potential senders time window information representative of the defined time window.

20. The system according to claim 15 further adapted to receive selection indication over the communication network and adapted to receive manual input representative of other selection indication and to provide a discount to potential senders that send selection indication over the communication network.
